(19) United States
(12) Patent Application Publication
(10) Pub. No.: US 2024/0021990 A1
(43) Pub. Date: Jan. 18, 2024

(54) UPRIGHT MULTIPATH ANTENNA STRUCTURE

(71) Applicants: Yun-Chan TSAI, Taipei City (TW); ONEWAVE TECHNOLOGY CO., LTD., Taipei City (TW)

(72) Inventors: Yun-Chan TSAI, Taipei City (TW); Shi-Yu CHIU, Taipei City (TW); Po-Huai HUANG, Taipei City (TW); Shi-Hong YANG, Taipei City (TW); Chin-Yun HSU, Taipei City (TW)

(21) Appl. No.: 17/968,641

(22) Filed: Oct. 18, 2022

(30) Foreign Application Priority Data
Jul. 15, 2022 (TW) 111207629

(51) Int. Cl. H01Q 5/371; H01Q 1/22

(52) U.S. Cl. CPC H01Q 5/371; H01Q 1/2283

(57) ABSTRACT

An upright multipath antenna structure includes a base body, a first path antenna metal layer and a second path antenna metal layer. The base body includes a wiring section and a fixing section. The fixing section is connected to the wiring section. The first path antenna metal layer is arranged on the wiring section of the base body. The second path antenna metal layer is arranged on the wiring section of the base body and is electrically connected to the first path antenna metal layer. The base body includes a plurality of fixing columns. The fixing columns are arranged in the fixing section of the base body.

### BACKGROUND OF THE DISCLOSURE

### Technical Field

The present disclosure relates to a multipath antenna structure, and especially relates to an upright multipath antenna structure.

### Description of Related Art

Wireless communication products have antennas to transmit and receive wireless signals. With the rapid development of the technologies, many new technologies and new communication protocols have been proposed, such as WI-FI 5, Wi-Fi 6 and 5G, which make the wireless communication products need to transmit and receive more and more information wirelessly, and also cause the antennas of the wireless communication products to require wider bandwidth and to be able to be applied in multiple frequency bands.

However, the current antenna must have a complex structure in order to widen the bandwidth and in order to be applied in multiple frequency bands.

### SUMMARY OF THE DISCLOSURE

In order to solve the above-mentioned problems, an object of the present disclosure is to provide an upright multipath antenna structure.

In order to achieve the object of the present disclosure mentioned above, the upright multipath antenna structure of the present disclosure includes a base body, a first path antenna metal layer and a second path antenna metal layer. The base body includes a wiring section and a fixing section. The fixing section is connected to the wiring section. The first path antenna metal layer is arranged on the wiring section of the base body. The second path antenna metal layer is arranged on the wiring section of the base body and is electrically connected to the first path antenna metal layer. Moreover, the base body includes a plurality of fixing columns. The fixing columns are arranged in the fixing section of the base body.

Moreover, in an embodiment of the upright multipath antenna structure of the present disclosure mentioned above, the upright multipath antenna structure further includes a plurality of conductive columns. The conductive columns are arranged through the base body and are electrically connected to the first path antenna metal layer and the second path antenna metal layer.

Moreover, in an embodiment of the upright multipath antenna structure of the present disclosure mentioned above, the first path antenna metal layer includes a first section antenna metal layer and a second section antenna metal layer. The first section antenna metal layer is arranged on the wiring section of the base body. The second section antenna metal layer is arranged on the wiring section of the base body. The second section antenna metal layer is connected to the first section antenna metal layer and is electrically connected to the conductive columns. Moreover, the first section antenna metal layer of the first path antenna metal layer is rectangular.

Moreover, in an embodiment of the upright multipath antenna structure of the present disclosure mentioned above, the second path antenna metal layer includes a third section antenna metal layer, a fourth section antenna metal layer and a fifth section antenna metal layer. The third section antenna metal layer is arranged on the wiring section of the base body. The fourth section antenna metal layer is arranged on the wiring section of the base body. The fourth section antenna metal layer is connected to the third section antenna metal layer and is electrically connected to the conductive columns. The fifth section antenna metal layer is arranged on the wiring section of the base body and is electrically connected to the conductive columns. Moreover, the third section antenna metal layer of the second path antenna metal layer is rectangular. The fifth section antenna metal layer of the second path antenna metal layer is rectangular.

Moreover, in an embodiment of the upright multipath antenna structure of the present disclosure mentioned above, the upright multipath antenna structure further includes a third path antenna metal layer arranged on the wiring section of the base body and electrically connected to the first path antenna metal layer and the second path antenna metal layer.

Moreover, in an embodiment of the upright multipath antenna structure of the present disclosure mentioned above, the upright multipath antenna structure further includes a printed circuit board and a third path antenna metal layer. The fixing columns are inserted into the printed circuit board. The third path antenna metal layer is arranged on the printed circuit board and is electrically connected to the first path antenna metal layer and the second path antenna metal layer.

Moreover, in an embodiment of the upright multipath antenna structure of the present disclosure mentioned above, the first path antenna metal layer includes a first section antenna metal layer and a second section antenna metal layer. The first section antenna metal layer is arranged on the wiring section of the base body. The second section antenna metal layer is arranged on the wiring section of the base body. The second section antenna metal layer is connected to the first section antenna metal layer and is electrically connected to the conductive columns. Moreover, the first section antenna metal layer of the first path antenna metal layer is stepped.

Moreover, in an embodiment of the upright multipath antenna structure of the present disclosure mentioned above, the second path antenna metal layer includes a third section antenna metal layer, a fourth section antenna metal layer and a fifth section antenna metal layer. The third section antenna metal layer is arranged on the wiring section of the base body. The fourth section antenna metal layer is arranged on the wiring section of the base body. The fourth section antenna metal layer is connected to the third section antenna metal layer and is electrically connected to the conductive columns. The fifth section antenna metal layer is arranged on the wiring section of the base body and is electrically connected to the conductive columns. Moreover, the third section antenna metal layer of the second path antenna metal layer is inverted-stepped. The fourth section antenna metal layer of the second path antenna metal layer is rectangular. The fifth section antenna metal layer of the second path antenna metal layer is rectangular.

Moreover, in an embodiment of the upright multipath antenna structure of the present disclosure mentioned above, the upright multipath antenna structure further includes a third path antenna metal layer. The third path antenna metal layer is arranged on the wiring section of the base body and is electrically connected to the first path antenna metal layer and the second path antenna metal layer.

Moreover, in an embodiment of the upright multipath antenna structure of the present disclosure mentioned above, the upright multipath antenna structure further includes a printed circuit board and a third path antenna metal layer. The fixing columns are inserted into the printed circuit board. The third path antenna metal layer is arranged on the printed circuit board and is electrically connected to the first path antenna metal layer and the second path antenna metal layer.

Moreover, in an embodiment of the upright multipath antenna structure of the present disclosure mentioned above, the upright multipath antenna structure further includes a chip type passive component electrically connected to the first path antenna metal layer.

Moreover, in an embodiment of the upright multipath antenna structure of the present disclosure mentioned above, the upright multipath antenna structure further includes a printed circuit board. The printed circuit board defines a plurality of antenna slots. The printed circuit board includes a plurality of first soldering areas and a plurality of second soldering areas. The fixing columns are inserted into the antenna slots. The first path antenna metal layer and the second path antenna metal layer are soldered to the first soldering areas. The chip type passive component is soldered to the second soldering areas to be electrically connected to the first path antenna metal layer. Moreover, the chip type passive component is a chip type antenna, a chip type capacitor or a chip type inductor.

Moreover, in an embodiment of the upright multipath antenna structure of the present disclosure mentioned above, the upright multipath antenna structure further includes a printed circuit board and a plurality of second soldering areas. The printed circuit board defines a plurality of antenna slots. The printed circuit board includes a plurality of first soldering areas. The fixing columns are inserted into the antenna slots. The first path antenna metal layer and the second path antenna metal layer are soldered to the first soldering areas. The second soldering areas are arranged on the first path antenna metal layer. The chip type passive component is soldered to the second soldering areas to be electrically connected to the first path antenna metal layer. Moreover, the chip type passive component is a chip type antenna, a chip type capacitor or a chip type inductor.

The advantage of the present disclosure is to widen the bandwidth of the antenna and to be applied to multiple frequency bands with a simple structure.

Please refer to the detailed descriptions and figures of the present disclosure mentioned below for further understanding the technology, method and effect of the present disclosure achieving the predetermined purposes. It believes that the purposes, characteristic and features of the present disclosure can be understood deeply and specifically. However, the figures are only for references and descriptions, but the present disclosure is not limited by the figures.

### BRIEF DESCRIPTION OF THE DRAWINGS

FIG. 1 shows a three-dimensional diagram from an angle of the first embodiment of the upright multipath antenna structure of the present disclosure.

FIG. 2 shows a three-dimensional diagram from another angle of the first embodiment of the upright multipath antenna structure of the present disclosure.

FIG. 3 shows a three-dimensional diagram from an angle of the second embodiment of the upright multipath antenna structure of the present disclosure.

FIG. 4 shows a three-dimensional diagram from another angle of the second embodiment of the upright multipath antenna structure of the present disclosure.

FIG. 5 shows a schematic diagram of the application of the upright multipath antenna structure of the present disclosure.

FIG. 6 shows a three-dimensional perspective diagram from an angle of the third embodiment of the upright multipath antenna structure of the present disclosure.

FIG. 7 shows a three-dimensional perspective diagram from an angle of the fourth embodiment of the upright multipath antenna structure of the present disclosure.

FIG. 8 shows a three-dimensional diagram from an angle of the fifth embodiment of the upright multipath antenna structure of the present disclosure.

FIG. 9 shows a combination diagram of the sixth embodiment of the upright multipath antenna structure of the present disclosure.

FIG. 10 shows an exploded view of the sixth embodiment of the upright multipath antenna structure of the present disclosure.

FIG. 11 shows a combination diagram of the seventh embodiment of the upright multipath antenna structure of the present disclosure.

FIG. 12 shows an exploded view of the seventh embodiment of the upright multipath antenna structure of the present disclosure.

### DETAILED DESCRIPTION

In the present disclosure, numerous specific details are provided, to provide a thorough understanding of embodiments of the disclosure. Persons of ordinary skill in the art will recognize, however, that the present disclosure can be practiced without one or more of the specific details. In other instances, well-known details are not shown or described to avoid obscuring aspects of the present disclosure. Now please refer to the figures for the explanation of the technical content and the detailed description of the present disclosure:

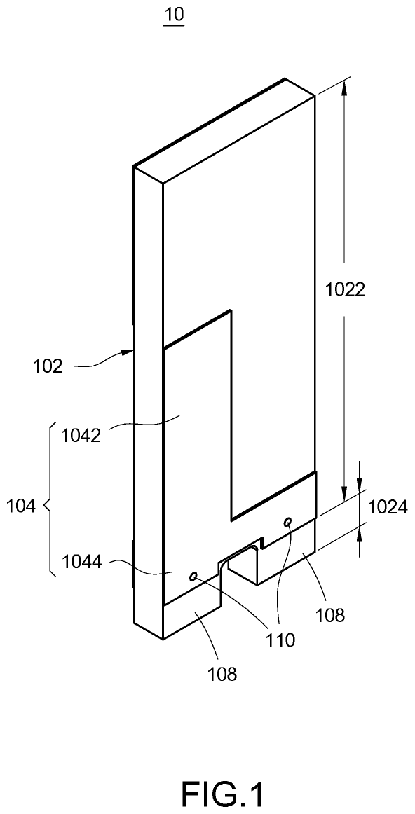

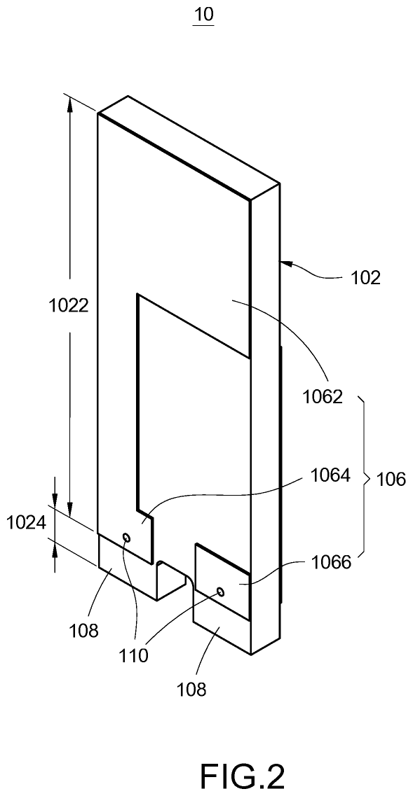

FIG. 1 shows a three-dimensional diagram from an angle of the first embodiment of the upright multipath antenna structure 10 of the present disclosure. Please refer to FIG. 2 at the same time, which shows a three-dimensional diagram from another angle of the first embodiment of the upright multipath antenna structure 10 of the present disclosure. As shown in FIG. 1 and FIG. 2, the upright multipath antenna structure 10 of the present disclosure includes a base body 102, a first path antenna metal layer 104, a second path antenna metal layer 106 and a plurality of conductive columns 110. The base body 102 includes a wiring section 1022 and a fixing section 1024. The fixing section 1024 is connected to the wiring section 1022. The first path antenna metal layer 104 is arranged on the wiring section 1022 of the base body 102. The second path antenna metal layer 106 is arranged on the wiring section 1022 of the base body 102 and is electrically connected to the first path antenna metal layer 104. The base body 102 includes a plurality of fixing columns 108. The fixing columns 108 are arranged in the fixing section 1024 of the base body 102. The conductive columns 110 are arranged through the base body 102 and are electrically connected to the first path antenna metal layer 104 and the second path antenna metal layer 106. The first path antenna metal layer 104 and the second path antenna metal layer 106 are arranged on different surfaces of the base body 102.

As shown in FIG. 1 and FIG. 2, the first path antenna metal layer 104 includes a first section antenna metal layer 1042 and a second section antenna metal layer 1044. The second path antenna metal layer 106 includes a third section antenna metal layer 1062, a fourth section antenna metal layer 1064 and a fifth section antenna metal layer 1066. The first section antenna metal layer 1042 of the first path antenna metal layer 104 is rectangular. The third section antenna metal layer 1062 of the second path antenna metal layer 106 is rectangular. The fifth section antenna metal layer 1066 of the second path antenna metal layer 106 is rectangular. The first section antenna metal layer 1042 is arranged on the wiring section 1022 of the base body 102. The second section antenna metal layer 1044 is arranged on the wiring section 1022 of the base body 102. The second section antenna metal layer 1044 is connected to the first section antenna metal layer 1042 and is electrically connected to the conductive columns 110. The third section antenna metal layer 1062 is arranged on the wiring section 1022 of the base body 102. The fourth section antenna metal layer 1064 is arranged on the wiring section 1022 of the base body 102. The fourth section antenna metal layer 1064 is connected to the third section antenna metal layer 1062 and is electrically connected to the conductive columns 110. The fifth section antenna metal layer 1066 is arranged on the wiring section 1022 of the base body 102 and is electrically connected to the conductive columns 110. As shown in FIG. 1 and FIG. 2, the first path antenna metal layer 104 and the second path antenna metal layer 106 form a dual-fork (cross) structure.

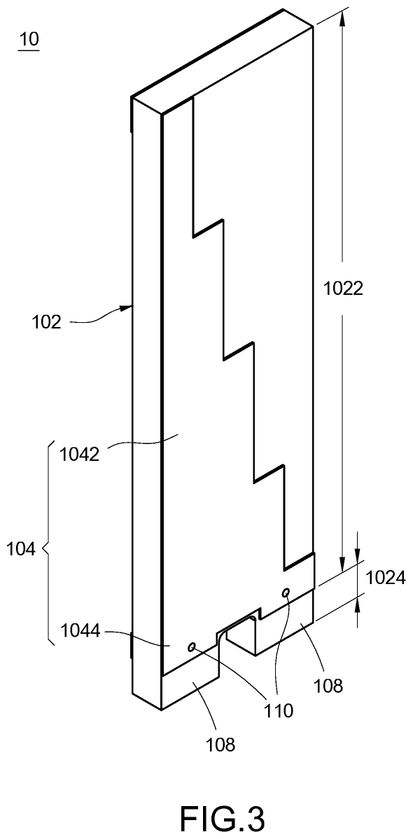

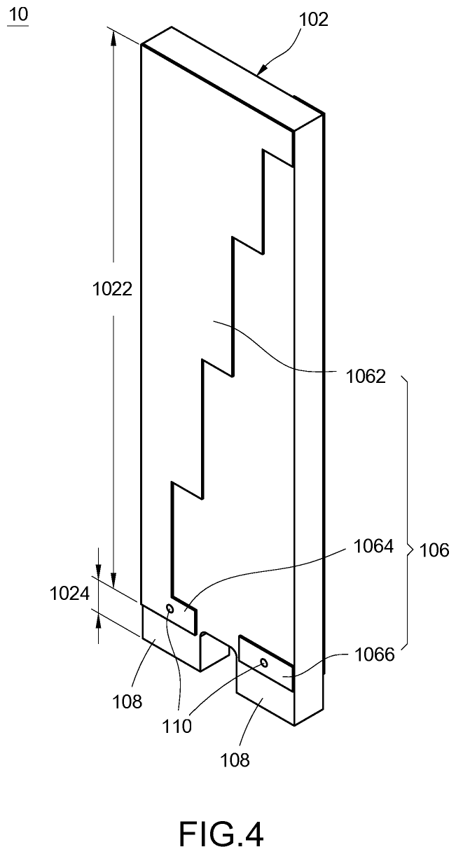

FIG. 3 shows a three-dimensional diagram from an angle of the second embodiment of the upright multipath antenna structure 10 of the present disclosure. Please refer to FIG. 4 at the same time, which shows a three-dimensional diagram from another angle of the second embodiment of the upright multipath antenna structure 10 of the present disclosure. As shown in FIG. 3 and FIG. 4, the upright multipath antenna structure 10 of the present disclosure includes a base body 102, a first path antenna metal layer 104, a second path antenna metal layer 106 and a plurality of conductive columns 110. The base body 102 includes a wiring section 1022 and a fixing section 1024. The fixing section 1024 is connected to the wiring section 1022. The first path antenna metal layer 104 is arranged on the wiring section 1022 of the base body 102. The second path antenna metal layer 106 is arranged on the wiring section 1022 of the base body 102 and is electrically connected to the first path antenna metal layer 104. The base body 102 includes a plurality of fixing columns 108. The fixing columns 108 are arranged in the fixing section 1024 of the base body 102. The conductive columns 110 are arranged through the base body 102 and are electrically connected to the first path antenna metal layer 104 and the second path antenna metal layer 106. The first path antenna metal layer 104 and the second path antenna metal layer 106 are arranged on different surfaces of the base body 102.

As shown in FIG. 3 and FIG. 4, the first path antenna metal layer 104 includes a first section antenna metal layer 1042 and a second section antenna metal layer 1044. The second path antenna metal layer 106 includes a third section antenna metal layer 1062, a fourth section antenna metal layer 1064 and a fifth section antenna metal layer 1066. The first section antenna metal layer 1042 of the first path antenna metal layer 104 is stepped. The third section antenna metal layer 1062 of the second path antenna metal layer 106 is inverted-stepped. The fourth section antenna metal layer 1064 of the second path antenna metal layer 106 is rectangular. The fifth section antenna metal layer 1066 of the second path antenna metal layer 106 is rectangular. The first section antenna metal layer 1042 is arranged on the wiring section 1022 of the base body 102. The second section antenna metal layer 1044 is arranged on the wiring section 1022 of the base body 102. The second section antenna metal layer 1044 is connected to the first section antenna metal layer 1042 and is electrically connected to the conductive columns 110. The third section antenna metal layer 1062 is arranged on the wiring section 1022 of the base body 102. The fourth section antenna metal layer 1064 is arranged on the wiring section 1022 of the base body 102. The fourth section antenna metal layer 1064 is connected to the third section antenna metal layer 1062 and is electrically connected to the conductive columns 110. The fifth section antenna metal layer 1066 is arranged on the wiring section 1022 of the base body 102 and is electrically connected to the conductive columns 110. As shown in FIG. 3 and FIG. 4, the first path antenna metal layer 104 and the second path antenna metal layer 106 form a dual-fork (cross) structure and a stepped graphic mirror design.

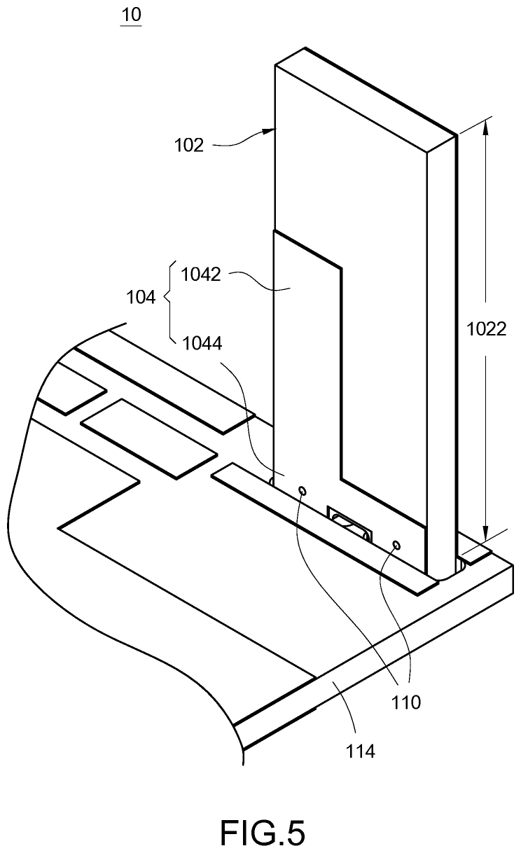

FIG. 5 shows a schematic diagram of the application of the upright multipath antenna structure 10 of the present disclosure. The upright multipath antenna structure 10 is applied to a printed circuit board 114. The fixing columns 108 are inserted into the printed circuit board 114. Although the upright multipath antenna structure 10 shown in FIG. 5 is the upright multipath antenna structure 10 of the first embodiment shown in FIG. 1 and FIG. 2, the upright multipath antenna structure 10 shown in FIG. 5 may be also the upright multipath antenna structure 10 of the second embodiment shown in FIG. 3 and FIG. 4.

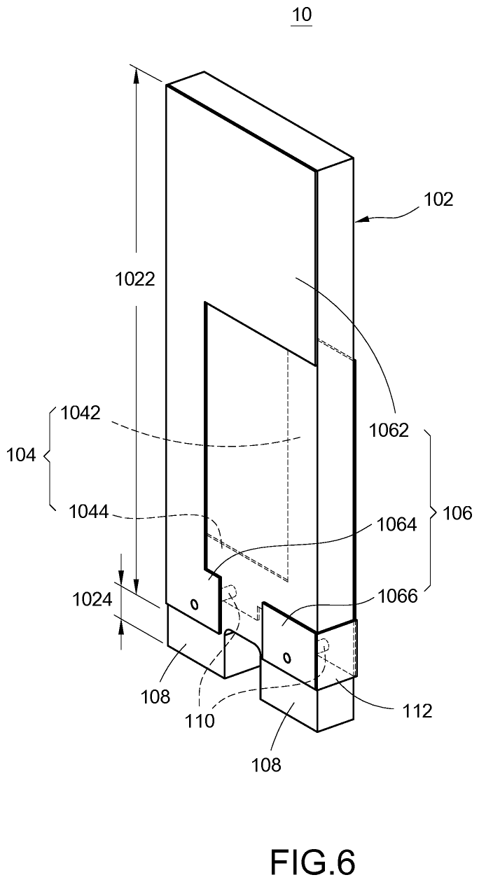

FIG. 6 shows a three-dimensional perspective diagram from an angle of the third embodiment of the upright multipath antenna structure 10 of the present disclosure. The upright multipath antenna structure 10 of the third embodiment shown in FIG. 6 is substantially the same as the upright multipath antenna structure 10 of the first embodiment shown in FIG. 1 and FIG. 2, so the description of FIG. 6 is omitted here. The difference is that the upright multipath antenna structure 10 of the third embodiment shown in FIG. 6 further includes a third path antenna metal layer 112 which is arranged on the wiring section 1022 of the base body 102 and is electrically connected to the first path antenna metal layer 104 and the second path antenna metal layer 106. The third path antenna metal layer 112 can increase the bandwidth and performance of the antenna. The first path antenna metal layer 104, the second path antenna metal layer 106 and the third path antenna metal layer 112 are arranged on different surfaces of the base body 102.

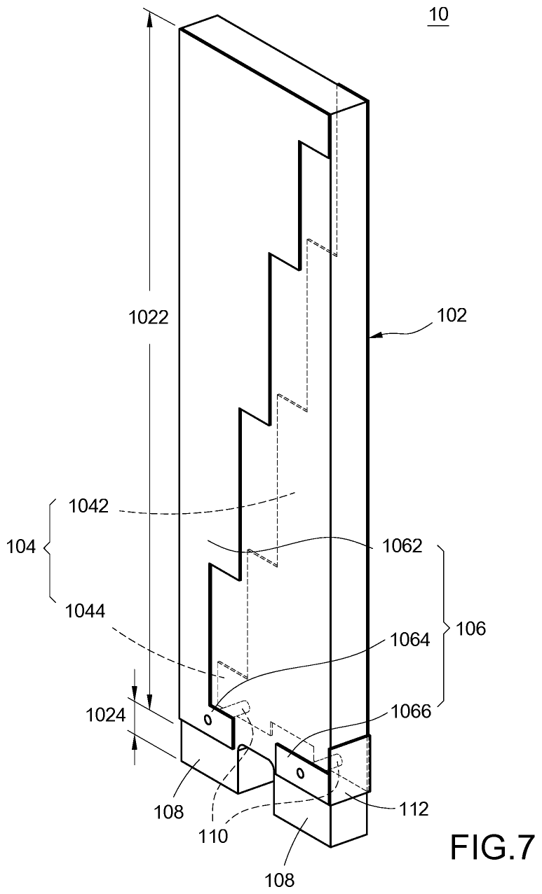

FIG. 7 shows a three-dimensional perspective diagram from an angle of the fourth embodiment of the upright multipath antenna structure 10 of the present disclosure. The upright multipath antenna structure 10 of the fourth embodiment shown in FIG. 7 is substantially the same as the upright multipath antenna structure 10 of the second embodiment shown in FIG. 3 and FIG. 4, so the description of FIG. 7 is omitted here. The difference is that the upright multipath antenna structure 10 of the fourth embodiment shown in FIG. 7 further includes a third path antenna metal layer 112 which is arranged on the wiring section 1022 of the base body 102 and is electrically connected to the first path antenna metal layer 104 and the second path antenna metal layer 106. The third path antenna metal layer 112 can increase the bandwidth and performance of the antenna. The first path antenna metal layer 104, the second path antenna metal layer 106 and the third path antenna metal layer 112 are arranged on different surfaces of the base body 102.

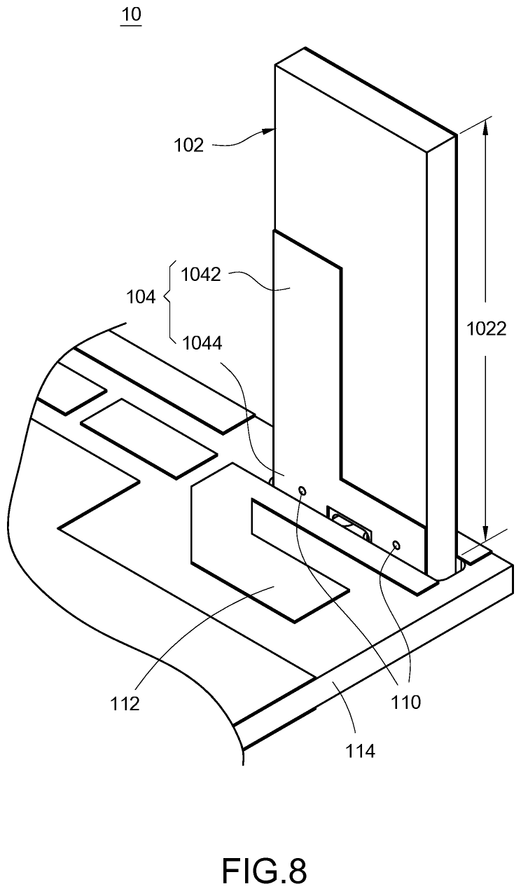

FIG. 8 shows a three-dimensional diagram from an angle of the fifth embodiment of the upright multipath antenna structure 10 of the present disclosure. The upright multipath antenna structure 10 of the fifth embodiment shown in FIG. 8 is substantially the same as the upright multipath antenna structure 10 of the first embodiment shown in FIG. 1 and FIG. 2, so the description of FIG. 8 is omitted here. The difference is that the upright multipath antenna structure 10 of the fifth embodiment shown in FIG. 8 further includes a printed circuit board 114 and a third path antenna metal layer 112. The fixing columns 108 are inserted into the printed circuit board 114. The third path antenna metal layer 112 is arranged on the printed circuit board 114 and is electrically connected to the first path antenna metal layer 104 and the second path antenna metal layer 106. The third path antenna metal layer 112 can increase the bandwidth and performance of the antenna.

Although the upright multipath antenna structure 10 shown in FIG. 8 is the upright multipath antenna structure 10 of the first embodiment shown in FIG. 1 and FIG. 2 plus the printed circuit board 114 and the third path antenna metal layer 112 shown in FIG. 8, in the present disclosure, the upright multipath antenna structure 10 of the second embodiment shown in FIG. 3 and FIG. 4 can also be combined with the printed circuit board 114 and the third path antenna metal layer 112 shown in FIG. 8 to form the sixth embodiment of the present disclosure; the similar contents are not repeated here.

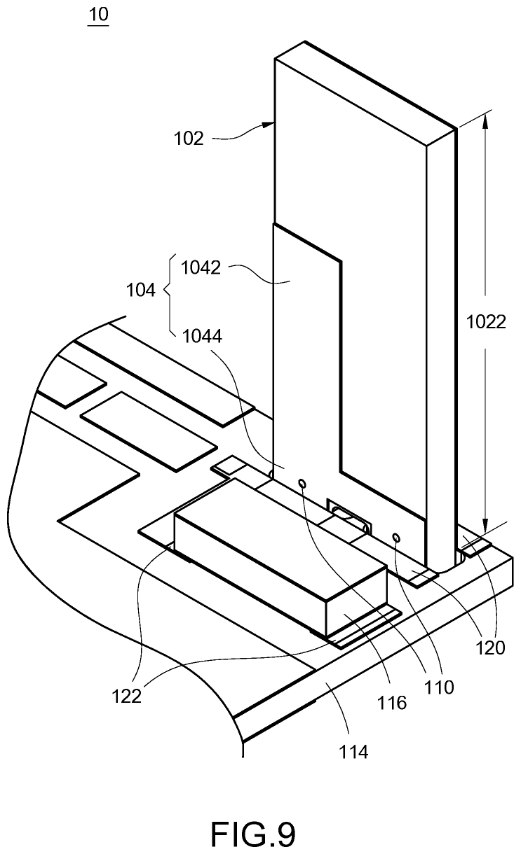

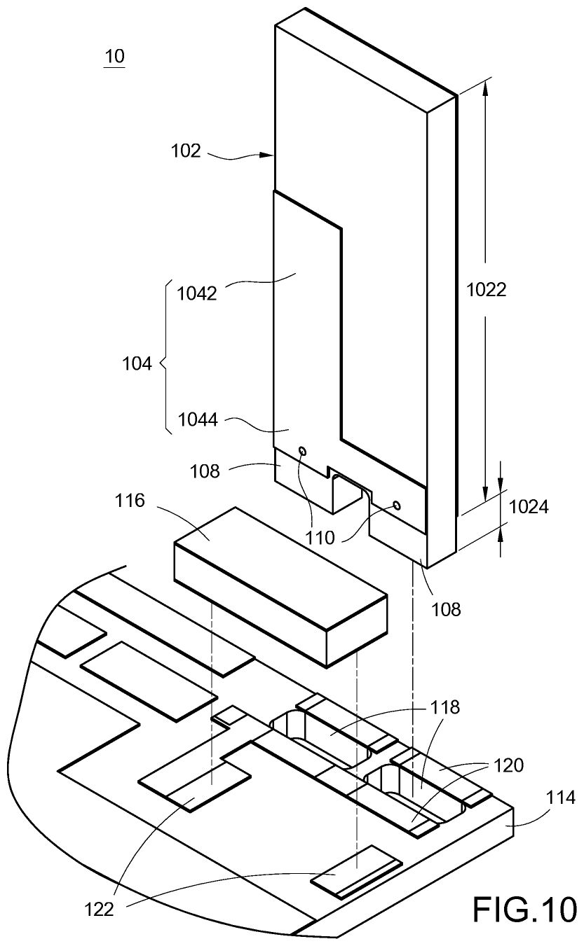

FIG. 9 shows a combination diagram of the sixth embodiment of the upright multipath antenna structure 10 of the present disclosure. Please refer to FIG. 10 at the same time, which shows an exploded view of the sixth embodiment of the upright multipath antenna structure 10 of the present disclosure. As shown in FIG. 9 and FIG. 10, the upright multipath antenna structure 10 of the present disclosure includes a base body 102, a first path antenna metal layer 104, a second path antenna metal layer 106 (on the backside of the base body 102; as the second path antenna metal layer 106 shown in FIG. 2), a plurality of conductive columns 110, a printed circuit board 114 and a chip type passive component 116. The base body 102 includes a wiring section 1022 and a fixing section 1024. The base body 102 includes a plurality of fixing columns 108. The first path antenna metal layer 104 includes a first section antenna metal layer 1042 and a second section antenna metal layer 1044. The printed circuit board 114 defines a plurality of antenna slots 118. The printed circuit board 114 includes a plurality of first soldering areas 120 and a plurality of second soldering areas 122.

The fixing section 1024 is connected to the wiring section 1022. The first path antenna metal layer 104 is arranged on the wiring section 1022 of the base body 102. The second path antenna metal layer 106 is arranged on the wiring section 1022 of the base body 102 and is electrically connected to the first path antenna metal layer 104. The conductive columns 110 are arranged through the base body 102 and are electrically connected to the first path antenna metal layer 104 and the second path antenna metal layer 106. The fixing columns 108 are arranged in the fixing section 1024 of the base body 102. The fixing columns 108 are inserted into the antenna slots 118. The first path antenna metal layer 104 and the second path antenna metal layer 106 are soldered to the first soldering areas 120. The chip type passive component 116 is soldered to the second soldering areas 122 to be electrically connected to the first path antenna metal layer 104. According to the number of the fixing columns 108, a corresponding number of the first soldering areas 120 is required for connecting; for example, if the number of the fixing columns 108 is two (while the number of the antenna slots 118 is also two), the number of the first soldering areas 120 is four. The first soldering areas 120 are aligned with the edges of the antenna slots 118. The chip type passive component 116 is used as a third path antenna, and may be implemented by using, for example, a chip type antenna, a chip type capacitor or a chip type inductor.

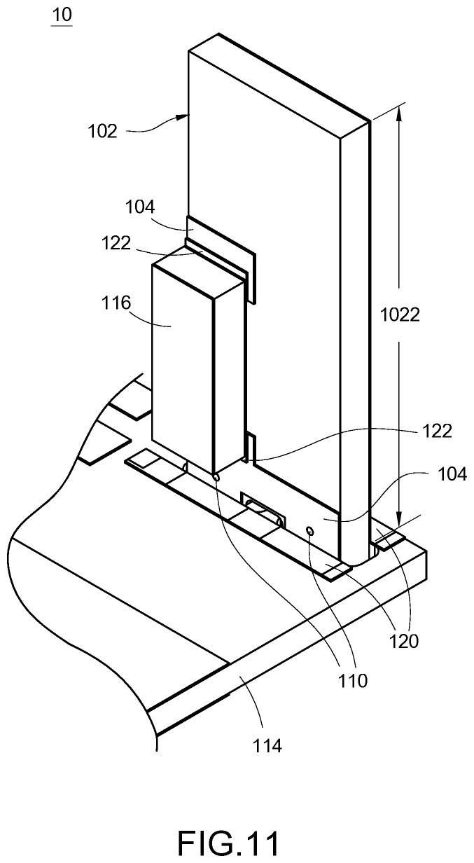

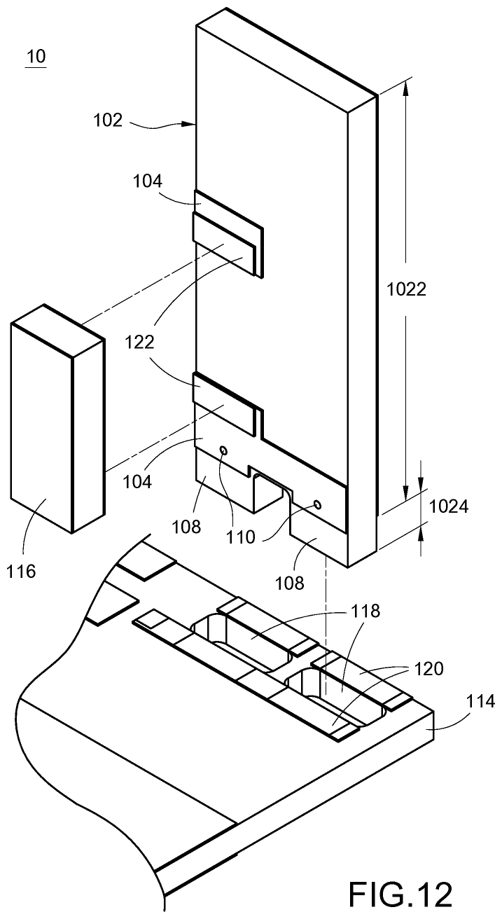

FIG. 11 shows a combination diagram of the seventh embodiment of the upright multipath antenna structure 10 of the present disclosure. Please refer to FIG. 12 at the same time, which shows an exploded view of the seventh embodiment of the upright multipath antenna structure 10 of the present disclosure. As shown in FIG. 11 and FIG. 12, the upright multipath antenna structure 10 of the present disclosure includes a base body 102, a first path antenna metal layer 104, a second path antenna metal layer 106 (on the backside of the base body 102; as the second path antenna metal layer 106 shown in FIG. 2), a plurality of conductive columns 110, a printed circuit board 114, a chip type passive component 116 and a plurality of second soldering areas 122. The base body 102 includes a wiring section 1022 and a fixing section 1024. The base body 102 includes a plurality of fixing columns 108. The printed circuit board 114 defines a plurality of antenna slots 118. The printed circuit board 114 includes a plurality of first soldering areas 120.

The fixing section 1024 is connected to the wiring section 1022. The first path antenna metal layer 104 is arranged on the wiring section 1022 of the base body 102. The second path antenna metal layer 106 is arranged on the wiring section 1022 of the base body 102 and is electrically connected to the first path antenna metal layer 104. The conductive columns 110 are arranged through the base body 102 and are electrically connected to the first path antenna metal layer 104 and the second path antenna metal layer 106. The second soldering areas 122 are arranged on the first path antenna metal layer 104. The fixing columns 108 are arranged in the fixing section 1024 of the base body 102. The fixing columns 108 are inserted into the antenna slots 118. The first path antenna metal layer 104 and the second path antenna metal layer 106 are soldered to the first soldering areas 120. The chip type passive component 116 is soldered to the second soldering areas 122 to be electrically connected to the first path antenna metal layer 104. According to the number of the fixing columns 108, a corresponding number of the first soldering areas 120 is required for connecting; for example, if the number of the fixing columns 108 is two (while the number of the antenna slots 118 is also two), the number of the first soldering areas 120 is four. The first soldering areas 120 are aligned with the edges of the antenna slots 118. The chip type passive component 116 is used as a third path antenna, and may be implemented by using, for example, a chip type antenna, a chip type capacitor or a chip type inductor.

The advantage of the present disclosure is to widen the bandwidth of the antenna and to be applied to multiple frequency bands with a simple structure. Moreover, the structure of the present disclosure is upright and stable.

Although the present disclosure has been described with reference to the embodiment thereof, it will be understood that the disclosure is not limited to the details thereof. Various substitutions and modifications have been suggested in the foregoing description, and others will occur to those of ordinary skill in the art. Therefore, all such substitutions and modifications are intended to be embraced within the scope of the disclosure as defined in the appended claims.

What is claimed is:

1. An upright multipath antenna structure comprising:
a base body comprising a wiring section and a fixing section, wherein the fixing section is connected to the wiring section;
a first path antenna metal layer arranged on the wiring section of the base body; and
a second path antenna metal layer arranged on the wiring section of the base body and electrically connected to the first path antenna metal layer,
wherein the base body comprises a plurality of fixing columns; the fixing columns are arranged in the fixing section of the base body.

2. The upright multipath antenna structure of claim 1, further comprising:
a plurality of conductive columns arranged through the base body and electrically connected to the first path antenna metal layer and the second path antenna metal layer.

3. The upright multipath antenna structure of claim 2, wherein the first path antenna metal layer comprises:
a first section antenna metal layer arranged on the wiring section of the base body; and
a second section antenna metal layer arranged on the wiring section of the base body, and connected to the first section antenna metal layer and electrically connected to the conductive columns,
wherein the first section antenna metal layer of the first path antenna metal layer is rectangular.

4. The upright multipath antenna structure of claim 3, wherein the second path antenna metal layer comprises:
a third section antenna metal layer arranged on the wiring section of the base body;
a fourth section antenna metal layer arranged on the wiring section of the base body, and connected to the third section antenna metal layer and electrically connected to the conductive columns; and
a fifth section antenna metal layer arranged on the wiring section of the base body and electrically connected to the conductive columns,
wherein the third section antenna metal layer of the second path antenna metal layer is rectangular; the fifth section antenna metal layer of the second path antenna metal layer is rectangular.

5. The upright multipath antenna structure of claim 4, further comprising:
a third path antenna metal layer arranged on the wiring section of the base body and electrically connected to the first path antenna metal layer and the second path antenna metal layer.

6. The upright multipath antenna structure of claim 4, further comprising:
a printed circuit board, wherein the fixing columns are inserted into the printed circuit board; and
a third path antenna metal layer arranged on the printed circuit board and electrically connected to the first path antenna metal layer and the second path antenna metal layer.

7. The upright multipath antenna structure of claim 2, wherein the first path antenna metal layer comprises:
a first section antenna metal layer arranged on the wiring section of the base body; and
a second section antenna metal layer arranged on the wiring section of the base body, and connected to the first section antenna metal layer and electrically connected to the conductive columns,
wherein the first section antenna metal layer of the first path antenna metal layer is stepped.

8. The upright multipath antenna structure of claim 7, wherein the second path antenna metal layer comprises:
a third section antenna metal layer arranged on the wiring section of the base body;
a fourth section antenna metal layer arranged on the wiring section of the base body, and connected to the third section antenna metal layer and electrically connected to the conductive columns; and
a fifth section antenna metal layer arranged on the wiring section of the base body and electrically connected to the conductive columns,
wherein the third section antenna metal layer of the second path antenna metal layer is inverted-stepped; the fourth section antenna metal layer of the second path antenna metal layer is rectangular; the fifth section antenna metal layer of the second path antenna metal layer is rectangular.

9. The upright multipath antenna structure of claim 8, further comprising:
a third path antenna metal layer arranged on the wiring section of the base body and electrically connected to the first path antenna metal layer and the second path antenna metal layer.

10. The upright multipath antenna structure of claim 8, further comprising:
a printed circuit board, wherein the fixing columns are inserted into the printed circuit board; and
a third path antenna metal layer arranged on the printed circuit board and electrically connected to the first path antenna metal layer and the second path antenna metal layer.

11. The upright multipath antenna structure of claim 2, further comprising:
a chip type passive component electrically connected to the first path antenna metal layer.

12. The upright multipath antenna structure of claim 11, further comprising:
a printed circuit board defining a plurality of antenna slots and comprising a plurality of first soldering areas and a plurality of second soldering areas,
wherein the fixing columns are inserted into the antenna slots; the first path antenna metal layer and the second path antenna metal layer are soldered to the first soldering areas; the chip type passive component is soldered to the second soldering areas to be electrically connected to the first path antenna metal layer; the chip type passive component is a chip type antenna, a chip type capacitor or a chip type inductor.

13. The upright multipath antenna structure of claim 11, further comprising:
a printed circuit board defining a plurality of antenna slots and comprising a plurality of first soldering areas, wherein the fixing columns are inserted into the antenna slots; the first path antenna metal layer and the second path antenna metal layer are soldered to the first soldering areas; and
a plurality of second soldering areas arranged on the first path antenna metal layer,
wherein the chip type passive component is soldered to the second soldering areas to be electrically connected to the first path antenna metal layer; the chip type passive component is a chip type antenna, a chip type capacitor or a chip type inductor.
